(19) United States
(12) Patent Application Publication
(10) Pub. No.: US 2015/0340141 A1
(43) Pub. Date: Nov. 26, 2015

(54) SUPERCONDUCTIVE ELECTROMAGNET DEVICE

(71) Applicant: Sumitomo Heavy Industries, Ltd., Tokyo (JP)

(72) Inventor: Jun Yoshida, Kanagawa (JP)

(21) Appl. No.: 14/720,274

(22) Filed: May 22, 2015

(30) Foreign Application Priority Data
May 26, 2014 (JP) 2014-107807

(51) Int. Cl. H01F 6/06; H01F 3/00; H01F 6/00

(52) U.S. Cl. CPC H01F 6/06; H01F 6/008; H01F 3/00

(57) ABSTRACT

A superconductive electromagnet includes a first coil portion that is arranged close to a gap of a yoke, a second coil portion that is arranged farther from the gap than the first coil portion, and first and second power sources that supply currents to the first and second coil portions, respectively. This configuration can change respective values of the currents flowing in the first and second coil portions. The value of the current flowing in the first coil portion is set to be greater than the value of the current flowing in the second coil portion, thereby increasing distribution of the value of the current flowing in the first coil portion and decreasing distribution of the current flowing in the second coil portion. When a magnetomotive force generated by the superconductive coil is applied in the same manner, a cross-sectional area of the second coil portion is reduced.

### RELATED APPLICATIONS

Priority is claimed to Japanese Patent Application No. 2014-107807, filed May 26, 2014, the entire content of which is incorporated herein by reference.

### BACKGROUND

1. Technical Field

Certain embodiments of the invention relate to a superconductive electromagnet device.

2. Description of Related Art

For example, in a charged particle beam therapy apparatus for performing therapy by irradiating a charged particle beam to a patient, an apparatus is known which deflects the charged particle beam by using a superconductive electromagnet as a deflection electromagnet for forming a deflection magnet field around a track of the charged particle beam (for example, refer to the related art).

### SUMMARY

According to an embodiment of the invention, there is provided a superconductive electromagnet device including a pair of superconductive coils that respectively have a first coil portion and a second coil portion which are arranged around a central axis, a pair of iron cores that have a gap between the pair of superconductive coils in a direction of the central axis, and that form a pair of magnetic poles across the gap, a first power source that supplies a current to the first coil portion which is arranged closer to the gap than the second coil portion, and a second power source that supplies a current to the second coil portion.

A superconductive electromagnet device according to another embodiment of the invention includes a pair of superconductive coils that respectively have a first coil portion and a second coil portion which are arranged around a central axis, and a pair of iron cores that have a gap between the pair of superconductive coils in a direction of the central axis, and that form a pair of magnetic poles across the gap. The first coil portion is arranged closer to the gap than the second coil portion, and winding density of the first coil portion is greater than winding density of the second coil portion.

A superconductive electromagnet device according to further another embodiment of the invention includes a pair of superconductive coils that respectively have a first coil portion and a second coil portion which are arranged around a central axis, and a pair of iron cores that have a gap between the pair of superconductive coils in a direction of the central axis, and that form a pair of magnetic poles across the gap. The first coil portion is arranged closer to the gap than the second coil portion, and current density of the first coil portion is greater than current density of the second coil portion.

### BRIEF DESCRIPTION OF THE DRAWINGS

FIG. 1 is a schematic view illustrating an embodiment of a charged particle beam irradiation apparatus.

FIG. 2 is a front view illustrating a magnet device according to an embodiment of the invention.

FIG. 3 is a sectional view taken by intersecting a track of a charged particle beam of the magnet device illustrated in FIG. 2.

FIGS. 4A to 4C are perspective views illustrating an example of a shape of a superconductive coil.

FIG. 5 is a circuit diagram illustrating an electric circuit for supplying a current to a first coil portion and an electric circuit for supplying a current to a second coil portion.

FIGS. 6A and 6B are views illustrating magnetic lines and density of a magnetic flux in a yoke.

FIG. 7 is a circuit diagram illustrating an electric circuit for supplying a current to a superconductive coil of a magnet device according to a second embodiment of the invention.

FIG. 8 is a cross-sectional view illustrating a superconductive coil of a magnet device according to a third embodiment of the invention.

FIGS. 9A and 9B are cross-sectional views illustrating a superconductive coil of a magnet device according to a fourth embodiment of the invention.

### DETAILED DESCRIPTION

The maximum current value which can energize a superconductive coil of a superconductive electromagnet varies depending on intensity of a magnetic field in the environment where the superconductive coil is arranged. Specifically, the superconductive coil is adversely affected by a magnetic flux leaking from a gap between iron cores, and density of the magnetic flux becomes greater as a position is closer to the gap, thereby limiting the maximum current value which can energize the superconductive coil. Consequently, in the superconductive coil, a portion arranged far from the gap has a margin in the maximum current value which can energize the superconductive coil. Accordingly, the portion is wastefully used.

Since a material for the superconductive coil is expensive, it is necessary to forbid wasteful use of the material for the superconductive coil. It is desirable to provide a superconductive electromagnet device which can reduce an amount of the material used for the superconductive coil, when a magnetomotive force is applied in the same manner.

The superconductive electromagnet device according to an embodiment of the invention includes the first power source that supplies a current to the first coil portion which is arranged close to the gap between the iron cores and the second power source that supplies a current to the second coil portion which is arranged far from the gap between the iron cores. Accordingly, this configuration can change each value of the currents flowing in the first coil portion and the second coil portion. In the superconductive electromagnet device according to the embodiment of the invention, the value of the current flowing in the first coil portion is set to be greater than the value of the current flowing in the second coil portion. Therefore, it is possible to reduce a cross-sectional area of the superconductive coil in the second coil portion by increasing distribution of the values of the current flowing in the first coil portion and by decreasing distribution of the values of the current flowing in the second coil portion, when a magnetomotive force generated by the superconductive coil is applied in the same manner. As a result, it is possible to reduce an amount of a material to be used for the superconductive coil.

In the superconductive electromagnet device according to the embodiment of the invention, the winding density of the first coil portion which is arranged close to the gap between the iron cores is greater than the winding density of the second coil portion which is arranged far from the gap. The winding density represents an occupied ratio of the cross-sectional area of the superconductive coil per unit cross-sectional area. For example, it is possible to increase the winding density by tightly winding coils so as to bring the coils into close contact with each other. It is possible to decrease the winding density by loosening the coils so as to form a clearance between the coils. The superconductive electromagnet device can generate a difference in the current density by generating a difference in the winding density per unit cross-sectional area between the coil portions close to and far from the gap. Accordingly, it is possible to reduce a cross-sectional area of the superconductive coil in the second coil portion by increasing distribution of the values of the current flowing in the first coil portion and by decreasing distribution of the values of the current flowing in the second coil portion, when a magnetomotive force generated by the superconductive coil is applied in the same manner. As a result, it is possible to reduce an amount of a material to be used for the superconductive coil.

In the superconductive electromagnet device according to the embodiment of the invention, the current density of the first coil portion which is arranged close to the gap between the iron cores is greater than the current density of the second coil portion which is arranged far from the gap. The current density represents an amount of electricity flowing per unit time in a direction perpendicular to unit cross-sectional area. The superconductive electromagnet device can generate a difference in the current density by arranging the coil portions close to or far from the gap. Accordingly, it is possible to reduce a cross-sectional area of the superconductive coil in the second coil portion by increasing distribution of the values of the current flowing in the first coil portion and by decreasing distribution of the values of the current flowing in the second coil portion, when a magnetomotive force generated by the superconductive coil is applied in the same manner. As a result, it is possible to reduce an amount of a material to be used for the superconductive coil.

Hereinafter, preferred embodiments according to the invention will be described in detail with reference to the drawings. The same reference numerals are given to the same elements or equivalent elements in each drawing, and thus repeated description thereof will be omitted. Terms of “upstream” and “downstream” respectively mean an upstream side (accelerator side) and a downstream side (patient side) of an emitted charged particle beam.

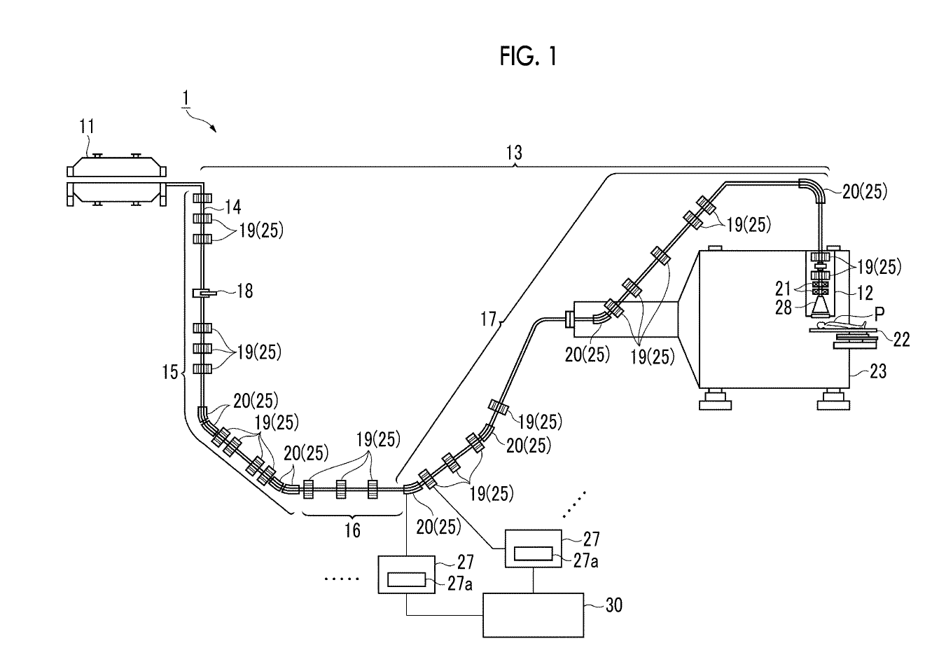

As illustrated in FIG. 1, a charged particle beam therapy apparatus 1 is an apparatus used for cancer therapy using radiotherapy, and includes an accelerator 11 which accelerates a charged particle beam so as to emit a charge particle beam, an irradiation nozzle 12 (irradiation unit) which irradiates an irradiation target with the charged particle beam, a beam transport line 13 (transport line) which transports the charged particle beam emitted from the accelerator 11 to the irradiation nozzle 12, a degrader 18 (energy adjustment unit) which is disposed in the beam transport line 13 and degrades energy of the charged particle beam so as to adjust a range of the charged particle beam, multiple electromagnets 25 which are disposed in the beam transport line 13, electromagnet power sources 27 which are respectively disposed corresponding to each of the multiple electromagnets 25, and a control unit 30 which controls the overall charged particle beam therapy apparatus 1. The embodiment described herein employs a cyclotron as the accelerator 11. However, without being limited thereto, the embodiment may employ other generation sources for generating the charged particle beam, such as a synchrotron, a synchrocyclotron, and a linear accelerator, for example. In addition, as the cyclotron, a ring cyclotron and an AVF cyclotron may be employed.

The charged particle beam therapy apparatus 1 irradiates a tumor (irradiation target) of a patient P lying on a therapy bed 22 with the charged particle beam emitted from the accelerator 11. The charged particle beam is obtained by accelerating a particle having a charge at high speed, and is a proton beam or a heavy particle (heavy ion) beam. The charged particle beam therapy apparatus 1 according to the embodiment described herein performs irradiation of the charged particle beam by means of a so-called scanning method, and virtually divides (slices) the irradiation target in a depth direction so as to irradiate every slice plane (layer) in an irradiation range on the layer with the charged particle beam.

For example, an irradiation method using the scanning method includes spot-type scanning irradiation and a raster-type scanning irradiation. The spot-type scanning irradiation is a method in which beam (charged particle beam) irradiation is stopped once if irradiation is completed for one spot in the irradiation range, and irradiation is performed for the subsequent spot after the irradiation is well prepared for the subsequent spot. In contrast, the raster-type scanning irradiation is a method in which the irradiation is not intermitted for the irradiation range on the same layer, and the beam irradiation is continuously performed. In this way, according the raster-type scanning irradiation, the beam irradiation is continuously performed for the irradiation range on the same layer. Therefore, unlike the spot-type scanning irradiation, the irradiation range is not configured to include multiple spots.

The irradiation nozzle 12 is attached to an inner side of a rotary gantry 23 which can rotate around the therapy bed 22 by 360 degrees, and is adapted to be movable to any desired rotation position by the rotary gantry 23. The irradiation nozzle 12 includes a focusing electromagnet 19, a scanning electromagnet 21, and a vacuum duct 28 (all to be described later). The scanning electromagnet 21 is disposed in the irradiation nozzle 12. The scanning electromagnet 21 has an X-direction scanning electromagnet for scanning a surface intersecting an irradiation direction of the charged particle beam with the charged particle beam in an X-direction and a Y-direction scanning electromagnet for scanning the surface intersecting the irradiation direction of the charged particle beam with the charged particle beam in a Y-direction which intersects the X-direction. In addition, the charged particle beam used for scanning by the scanning electromagnet 21 is deflected in the X-direction and/or in the Y-direction. Accordingly, the vacuum duct 28 located on the further downstream side from the scanning electromagnet is configured so that a diameter thereof increases toward the downstream side.

The beam transport line 13 has a vacuum duct 14 through which the charged particle beam passes. The vacuum duct 14 internally maintains a vacuum state, thereby preventing a charged particle configuring the charged particle beam from being scattered by air or the like during transportation.

The beam transport line 13 has an energy selection system (ESS) 15 which selectively extracts the charged particle beam having an energy width narrower than a predetermined energy width from the charged particle beams emitted from the accelerator 11 and having the predetermined energy width, a beam transport system (BTS) 16 which transports the charged particle beam having the energy width selected by the ESS 15 in a state where energy is maintained, and a gantry transport system (GTS) 17 which transports the charged particle beam from the BTS 16 toward the rotary gantry 23.

The degrader 18 degrades the energy of the charged particle beam passing therethrough so as to adjust a range of the charged particle beam. A depth from a body surface of a patient to a tumor of the irradiation target varies depending on each patient. Accordingly, when the patient is irradiated with the charged particle beam, it is necessary to adjust the range which represents a reachable depth of the charged particle beam. The degrader 18 adjusts the energy of the charged particle beam emitted from the accelerator 11 with constant energy, thereby adjusting the charged particle beam so as to properly reach the irradiation target located at a predetermined depth inside the body of the patient. This energy adjustment of the charged particle beam is performed by the degrader 18 for every sliced layer of the irradiation target.

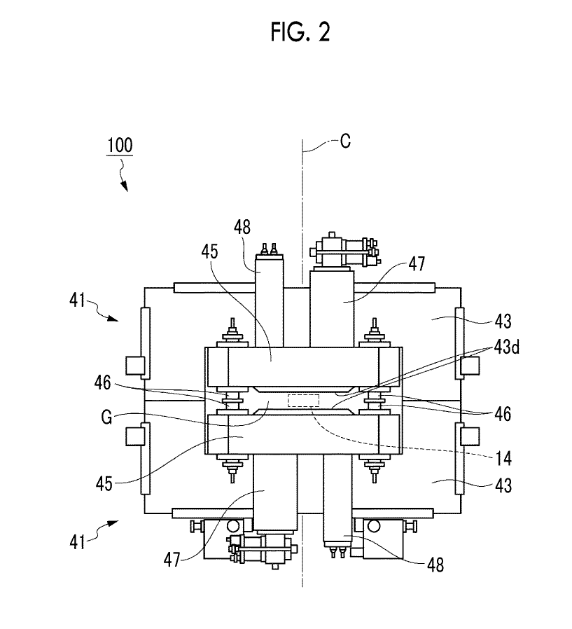

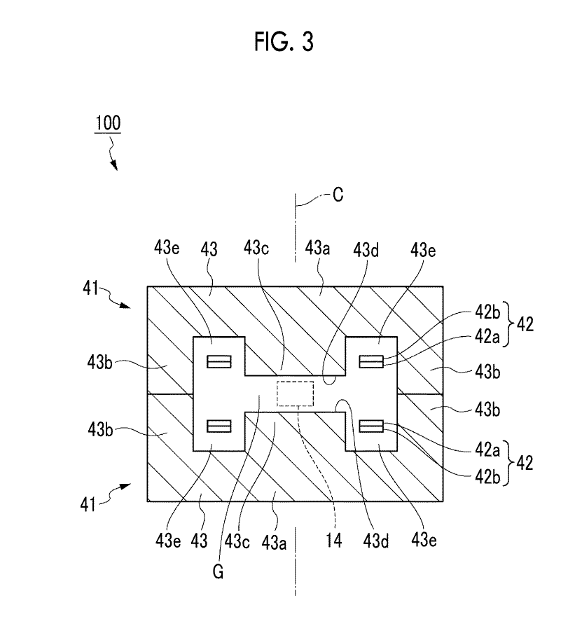

The electromagnet 25 is disposed at multiple locations of the beam transport line 13, and adjusts the charged particle beam so that a magnetic field enables the charged particle beam to be transported by using the beam transport line 13. The electromagnet 25 employs the focusing electromagnet 19 which focuses a beam diameter of the charged particle beam during the transportation, and a deflection electromagnet 20 which deflects the charged particle beam. In the following description, in some cases, the focusing electromagnet 19 and the deflection electromagnet 20 will be described as the electromagnet 25 without particular distinction therebetween. In addition, the electromagnet 25 is disposed at multiple locations on the further downstream side from the degrader 18 within at least the beam transport line 13. However, in the embodiment described herein, the electromagnet 25 is also disposed on the further upstream side from the degrader 18. Here, the focusing electromagnet 19 serving as the electromagnet 25 is also disposed on the upstream side of the degrader 18 in order to focus the beam diameter of the charged particle beam before the energy is adjusted by the degrader 18. A total number of the electromagnets 25 can be flexibly changed depending on a length of the beam transport line 13, and is set to approximately 10 to 40, for example. FIG. 1 illustrates only a portion of the electromagnet power source 27. However, in practice, the number of the disposed electromagnet power sources 27 is the same as the number of electromagnets 25. The embodiment described herein employs a magnet device 100 (to be described later, refer to FIGS. 2 and 3) as the deflection electromagnet 20.

A position of the degrader 18 and the electromagnet 25 within the beam transport line 13 is not particularly limited. However, according to the embodiment described herein, the degrader 18, the focusing electromagnet 19, and the deflection electromagnet 20 are disposed in the ESS 15. The focusing electromagnet 19 is disposed in the BTS 16. The focusing electromagnet 19 and the deflection electromagnet 20 are disposed in the GTS 17. As described above, the degrader 18 is disposed in the ESS 15 located between the accelerator 11 and the rotary gantry 23. More specifically, the degrader 18 is disposed on the accelerator 11 side (upstream side) rather than the rotary gantry 23 within the ESS 15.

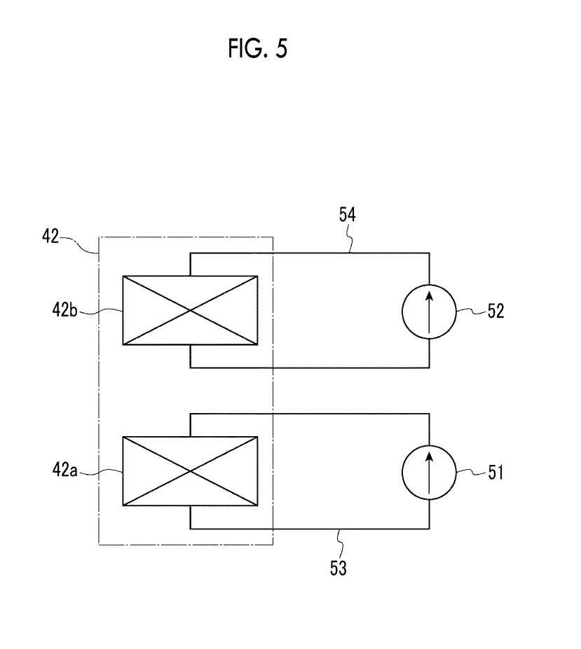

The electromagnet power source 27 generates a magnetic field of the electromagnet 25 by supplying a current to the corresponding electromagnet 25. The electromagnet power source 27 can set intensity of the magnetic field of the corresponding electromagnet 25 by adjusting the current supplied to the corresponding electromagnet 25. The electromagnet power source 27 adjusts the current supplied to the electromagnet 25 in response to a signal from the control unit 30. The electromagnet power source 27 is disposed one to one so as to correspond to each electromagnet 25. That is, the number of the disposed electromagnet power sources 27 is the same as the number of the electromagnets 25. In addition, the electromagnet power source 27 for supplying the current to the magnet device 100 serving as the deflection electromagnet 20 has a first power source 51 and a second power source 52 (all to be described later, refer to FIG. 5).

The following description indicates a relationship between a depth of each layer of the irradiation target and the current supplied to the electromagnet 25. That is, based on the depth of each layer, energy of the charged particle beam, which is needed to irradiate each layer with the charged particle beam, is determined, and an amount of the energy adjusted by the degrader 18 is determined. Here, if the energy of the charged particle beam is changed, intensity of a magnetic field which is needed to deflect and focus the charged particle beam is also changed. Therefore, the current supplied to the electromagnet 25 is determined so that the intensity of the magnetic field of the electromagnet 25 becomes intensity corresponding to the amount of the energy adjusted by the degrader 18.

The control unit 30 controls irradiation of the charged particle beam emitted from the accelerator 11 to the irradiation target. The control unit 30 controls the accelerator 11 so as to emit the charged particle beam. The control unit 30 controls the ESS 15, the BTS 16, and the GTS 17 so as to transport the charged particle beam emitted from the accelerator 11. In addition, the control unit 30 controls that the irradiation target is scanned using the charged particle beam.

Here, each time a therapy is carried out for a certain patient in a case of a charged particle beam therapy, a plan how to irradiate the patient with the charged particle beam is prepared (therapy plan). Therapy plan data determined during the therapy plan is transmitted from a therapy plan device (not illustrated) to the control unit 30 before the therapy is carried out, and is stored in the control unit 30. The therapy plan data includes an amount of energy adjusted by the degrader 18 for irradiating each layer of the irradiation target with the charged particle beam, and a parameter of the electromagnet 25 for irradiating all layers corresponding to the amount of energy adjusted by the degrader 18. In addition, the therapy plan data includes data related to a value of a current supplied to a superconductive coil 42 of a superconductive electromagnet 41 used as the deflection electromagnet 20.

Next, the magnet device (superconductive electromagnet device) 100 including the superconductive electromagnet 41 will be described. As illustrated in FIG. 2, the magnet device 100 is configured so that a pair of superconductive electromagnets 41 are vertically arranged to oppose each other. The superconductive electromagnet 41 includes a pair of cryostats 45 serving as a vacuum container for internally accommodating a coil unit 44, and a pair of yokes (iron cores) 43 disposed outside the cryostats 45.

The cryostat 45 of the superconductive electromagnet 41 on the upper side and the cryostat 45 of the superconductive electromagnet 41 on the lower side oppose each other in a vertically reversed state, and are connected to each other so as to be separated from each other via a strut 46. The magnet device 100 functions as the above-described deflection electromagnet 20 which bends a track of a charged particle beam B passing through a portion between the pair of cryostats 45.

FIG. 3 is a cross-sectional view taken by intersecting the track of the charged particle beam of the magnet device 100. FIG. 3 omits the illustration of the cryostat 45, and illustrates the pair of superconductive coils 42, the pair of yokes 43, and the vacuum duct 14. The vacuum duct 14 can be bought into an internally vacuum state, and is configured to form a conduit for the charged particle beam B passing therethrough. The pair of yokes 43 are arranged to oppose each other in the vertical direction, and guide a magnetic flux generated around the superconductive coil 42.

The yoke 43 includes a yoke main body 43a which is arranged along an illustrated lateral direction (direction intersecting a direction of a central axis C and a track of a charged particle beam) in a cross-sectional view illustrated in FIG. 3, a pair of protruding portions 43b which protrude in the direction of the central axis C from both end portions in the illustrated lateral direction of the yoke main body 43a, and a convex portion 43c which protrudes in the direction of the central axis C from the central portion in the illustrated lateral direction of the yoke main body 43a.

The pair of protruding portions 43b protrude in the same direction as the convex portion 43c, and further protrude in the direction of the central axis C than the convex portion 43c. In the pair of superconductive electromagnets 41, the opposing protruding portions 43b come into contact with each other, thereby forming a gap (clearance) G between the convex portions 43c opposing each other. The gap G is formed between distal end surfaces 43d of the opposing convex portions 43c in the direction of the central axis C, and the vacuum duct 14 is arranged in the gap G.

A concave portion 43e is formed on both sides of the convex portion 43c in the illustrated lateral direction. The concave portion 43e is formed between the convex portion 43c and the pair of protruding portions 43b, and the superconductive coil 42 is arranged in the concave portion 43e.

The superconductive electromagnet 41 includes the superconductive coil 42 which is energized so as to generate a magnetic flux, a cooler 47 which cools the superconductive coil 42, and a current introduction portion 48 which introduces a current to the superconductive coil 42 for energization. The superconductive coil 42 is arranged around the predetermined central axis C extending in the vertical direction, and has a substantially rectangular shape when viewed in the direction of the central axis C. The superconductive coil 42 has at least two or more different curvatures in the circumferential direction.

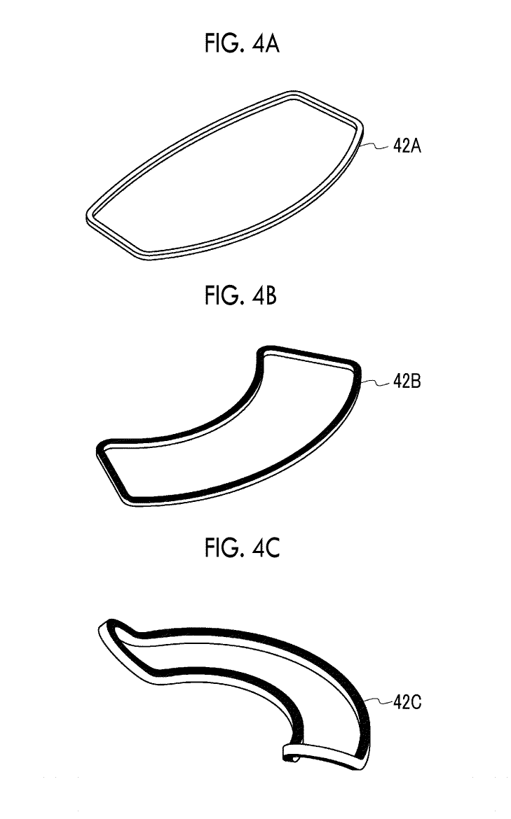

The shape of the superconductive coil 42 is not particularly limited. A D-type coil 42A having a substantially D-shape as illustrated in FIG. 4A may be employed, a racetrack coil 42B as illustrated in FIG. 4B may be employed, and a saddle-shaped coil 42C as illustrated in FIG. 4C may be employed. In addition, the superconductive coil 42 may have a shape which is symmetrical to the central axis, or may have a non-symmetrical shape.

The superconductive coil 42 has a configuration in which a superconductive wire is wound. A high-temperature superconductive wire may be used as the superconductive wire. For example, as high-temperature superconductive wire, Bi2223, Bi2212, Y123, MgB2, and an oxide superconductor may be used. As the superconductive wire, a low-temperature superconductive wire may be used.

The superconductive coil 42 has the first coil portion 42a and the second coil portion 42b, and has a two-stage configuration in which the first coil portion 42a and the second coil portion 42b are stacked on each other. The first coil portion 42a and the second coil portion 42b overlap each other in the direction of the central axis C. The first coil portion 42a is arranged close to the distal end surface 43d of the convex portion 43c, and the second coil portion 42b is arranged far from the distal end surface 43d of the convex portion 43c. In addition, the first coil portion 42a and the second coil portion 42b are supported inside the cryostat 45 by a wall surface of the cryostat 45.

FIG. 5 is a circuit diagram illustrating an electric circuit for supplying a current to the first coil portion 42a and an electric circuit for supplying a current to the second coil portion 42b. The magnet device 100 includes the first power source 51 for supplying a current to the first coil portion 42a and the second power source 52 for supplying a current to the second coil portion 42b. The first power source 51 is electrically connected to the first coil portion 42a via a current introduction portion, and the second power source 52 is electrically connected to the second coil portion 42b via a current introduction portion. The magnet device 100 includes an electric circuit 53 for supplying a current to the first coil portion 42a and an electric circuit 54 for supplying a current to the second coil portion 42b, which are provided independently.

In the magnet device 100, a stronger current flows from the first power source 51 than from the second power source 52. A value I₁ of a current flowing into the first coil portion 42a is greater than a value I₂ of a current flowing into the second coil portion 42b (I₁>I₂). The respective electric circuits 53 and 54 are configured so that the currents flowing into the first coil portion 42a and the second coil portion 42b flow in the same direction.

The cooler 47 is connected to the first coil portion 42a and the second coil portion 42b via a heat transfer member (not illustrated). Heat of the first coil portion 42a and the second coil portion 42b is transferred to the cooler 47 via the heat transfer member. The first coil portion 42a and the second coil portion 42b are cooled by the cooler 47 so as to maintain a predetermined temperature (for example, 4 K).

Next, an operation of the charged particle beam therapy apparatus 1 and the magnet device 100 according to the embodiment described herein will be described.

In the charged particle beam therapy apparatus 1, a charged particle is accelerated by the accelerator 11, and a charged particle beam emitted from the accelerator 11 is transported by the beam transport line 13. The charged particle beam transported by the beam transport line 13 is emitted from the irradiation nozzle 12, and a patient is irradiated with the charged particle beam for the purpose of therapy.

The magnet device 100 functioning as the deflection electromagnet 20 is disposed in the beam transport line 13 of the charged particle beam therapy apparatus 1. In the magnet device 100, the superconductive coil 42 is energized and a magnetic flux is generated around the superconductive coil 42. The magnetic flux passes through the yoke 43, and forms a magnetic circuit around the superconductive coil 42 so that the convex portion 43c of the pair of opposing yokes 43 becomes a magnetic pole. For example, in a case illustrated in FIG. 3, in accordance with a direction of a current flowing into the superconductive coil 42, a magnetomotive force acting upward is generated between the pair of convex portions 43c. In the magnet device 100, the vacuum duct 14 is arranged inside the gap G, and the charged particle beam is deflected by applying the magnetomotive force to the charged particle beam.

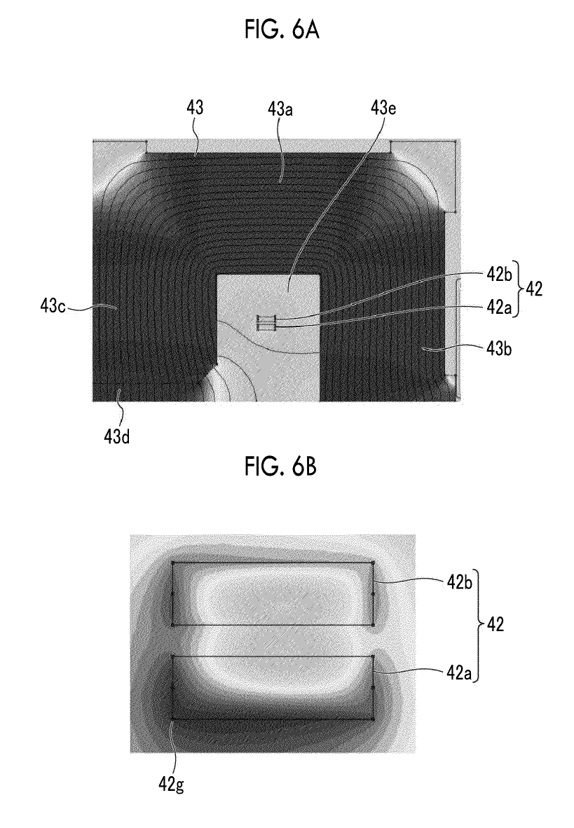

Here, referring to FIGS. 6A and 6B, a magnetic flux leaking from the convex portion 43c of the yoke 43 will be described. In FIGS. 6A and 6B, a region where density of the magnetic flux is great is illustrated by a darker region, and a region where density of the magnetic flux is small is illustrated by a brighter region. FIG. 6A illustrates magnetic lines and density of a magnetic flux in the yoke 43, and FIG. 6B illustrates density of a magnetic flux in the superconductive coil 42.

As illustrated in FIG. 6A, magnetic lines extend so as to face the protruding portion 43b on the protruding portion 43b side of the distal end surface 43d of the convex portion 43c. As illustrated in FIG. 6B, in the superconductive coil 42, the first coil portion 42a close to the gap G formed between the convex portions 43c of the yoke 43 has greater density of the magnetic flux than the second coil portion 42b far from the gap G. In addition, even in the first coil portion 42a, a corner portion 42g close to the gap G has greater density of the magnetic flux as compared to the other portions. The maximum current which can energize the coil is influenced by the density of the magnetic flux. Accordingly, as compared to the first coil portion 42a close to the gap G, the second coil portion 42b far from the gap G has a margin in the maximum current which can energize the coil.

The magnet device 100 includes the first power source 51 for supplying a current to the first coil portion 42a arranged close to the gap G and the second power source 52 for supplying a current to the second coil portion 42b arranged far from the gap G. In this manner, values (I₁>I₂) of the currents flowing into the first coil portion 42a and the second coil portion 42b can become different from each other. In the magnet device 100, the value I₁ of the current flowing into the first coil portion 42a is set to be greater than the value I₂ of the current flowing into the second coil portion 42b. In this manner, it is possible to increase distribution of values of the current flowing into the first coil portion 42a and to decrease distribution of values of the current flowing into the second coil portion 42b. As compared to the related art, when a magnetomotive force generated by the superconductive coil 42 is applied in the same manner, it is possible to reduce a cross-sectional area of the superconductive coil 42 in the second coil portion 42b. In other words, the magnetomotive force can also be guaranteed by decreasing the cross-sectional area of the superconductive coil 42. As a result, it is possible to reduce an amount of a material to be used for the superconductive coil 42.

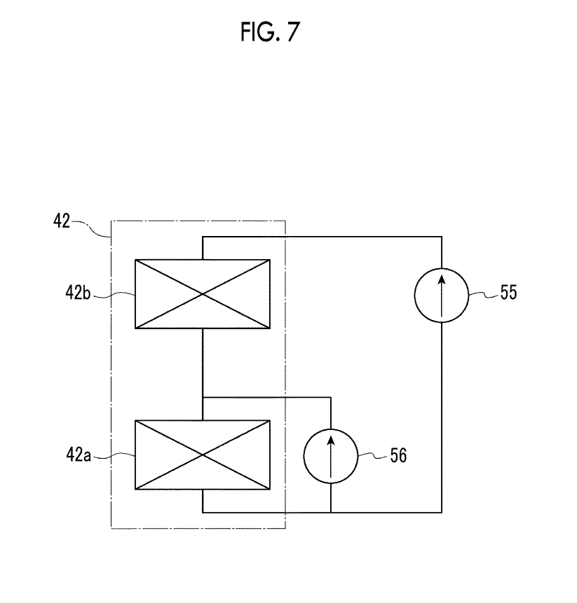

Next, a magnet device according to a second embodiment will be described. The magnet device according to the second embodiment is different from the magnet device 100 according to the first embodiment in that an electric circuit for supplying a current to the superconductive coil 42 is different. FIG. 7 is a circuit diagram illustrating the electric circuit for supplying the current to the superconductive coil 42 of the magnet device according to the second embodiment. The magnet device 100 according to the second embodiment includes a main power source 55 for supplying a current to the first coil portion 42a and the second coil portion 42b, and an auxiliary power source 56 for supplying a current to the first coil portion 42a. The first coil portion 42a and the second coil portion 42b are connected to each other in series so as to receive the current supplied by the main power source 55. The auxiliary power source 56 is electrically connected so as to supply the current to only the first coil portion 42a.

In the magnet device 100 according to the second embodiment having this configuration, the main power source 55 can supply the current to both the first coil portion 42a and the second coil portion 42b, and the auxiliary power source 56 can further supply the current to only the first coil portion 42a. According to the magnet device 100 of the second embodiment, the value I₁ of the current of the first coil portion 42a close to the gap G can be greater than the value I₂ of the current of the second coil portion 42b far from the gap G. In this manner, it is possible to generate a difference in the density of the currents between the first coil portion 42a and the second coil portion 42b. Therefore, it is possible to reduce an amount of a material to be used for the superconductive coil 42 by reducing a cross-sectional area of the second coil portion 42b having a margin in the maximum current which can energize the superconductive coil 42.

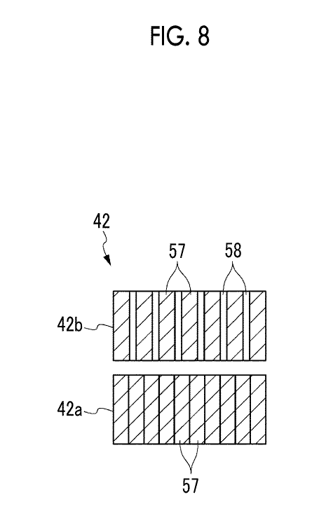

Next, a magnet device according to a third embodiment will be described. FIG. 8 is a cross-sectional view illustrating a superconductive coil of the magnet device according to the third embodiment. The magnet device according to the third embodiment is different from the magnet device 100 according to the first embodiment in that winding density of the first coil portion 42a is different from winding density of the second coil portion 42b. Specifically, the winding density of the first coil portion 42a close to the gap G is greater than the winding density of the second coil portion 42b far from the gap G. For example, in the second coil portion 42b, a clearance is formed between wires 57 adjacent to each other in the radial direction (illustrated lateral direction) of the superconductive coil 42. In the first coil portion 42a, the wires 57 are wound so that the wires 57 adjacent to each other in the radial direction of the superconductive coil 42 are brought into close contact with each other, thereby forming the superconductive coil 42. In the second coil portion 42b, the superconductive coil 42 may be formed by winding the wires 57 across a spacer 58. Currents are supplied to the magnet device according to the third embodiment so that a current value of the first coil portion 42a is the same as a current value of the second coil portion 42b. In this case, a current may be supplied to the first coil portion 42a and the second coil portion 42b from a common power source, or currents may be respectively supplied to the first coil portion 42a and the second coil portion 42b from different power sources.

According to this magnet device of the third embodiment, the winding density of the first coil portion 42a close to the gap G is greater than the winding density of the second coil portion 42b far from the gap G. Accordingly, it is possible to generate a difference in the current density per unit cross-sectional area between the first coil portion 42a and the second coil portion 42b. In this manner, it is possible to reduce an amount of a material to be used for the superconductive coil 42 while the magnetomotive force generated by the superconductive coil 42 is maintained.

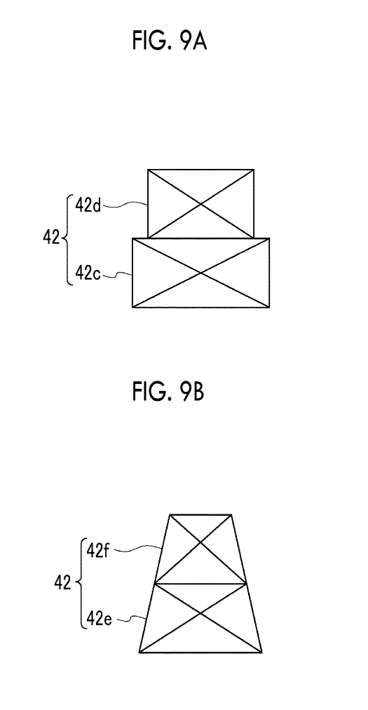

Next, a magnet device according to a fourth embodiment will be described. In the magnet device according to the fourth embodiment, a cross-sectional area of first coil portions 42c and 42e close to the gap G is larger than a cross-sectional area of second coil portions 42d and 42f far from the gap G. FIGS. 9A and 9B are cross-sectional views of a superconductive coil of the magnet device according to the fourth embodiment. FIG. 9A illustrates a type of superconductive coil whose cross-sectional area decreases stepwise, and FIG. 9B illustrates a type of superconductive coil whose cross-sectional area decreases as a distance is far away from the gap G. For example, the cross-sectional area of the coil portion represents the total sum of cross-sectional areas of wires per unit area.

Similarly to the above-described embodiments, according to the magnet device of the fourth embodiment, it is also possible to set distribution of values of currents flowing into the first coil portions 42c and 42e to be greater than distribution of values of currents flowing into the second coil portions 42d and 42f by generating a difference in the current density between the first coil portions 42c and 42e close to the gap G and the second coil portions 42d and 42f far from the gap G. It is possible to minimize the distribution of the values of the currents flowing into the second coil portions 42d and 42f. Accordingly, it is possible to reduce a cross-sectional area in the second coil portions 42d and 42f, when a magnetomotive force generated by the superconductive coil 42 is applied in the same manner. As a result, it is possible to reduce an amount of a material to be used for the superconductive coil 42.

Without being limited to the above-described embodiments, certain embodiments of the present invention can be modified as follows in various ways within the scope not departing from the concept of the invention.

In the above-described embodiments, a case has been described in which a superconductive coil portion has a two-stage configuration including the first coil portion and the second coil portion. The superconductive coil portion may be provided with another coil portion in addition to the first coil portion and the second coil portion, and may be configured to have a configuration in three or more stages. In this case, for example, current density is distributed so that the current density becomes greater sequentially from the coil portion closest to the gap G.

In the above-described embodiments, the first coil portion is close to the gap G and the second coil portion is far from the gap G in the direction of the central axis C. However, the first coil portion maybe close to the gap G and the second coil portion may be far from the gap G in a direction (illustrated lateral direction) orthogonal to the central axis C.

In the first embodiment, the charged particle beam therapy apparatus 1 including the magnet device 100 has been described. However, the charged particle beam therapy apparatus may include the superconductive electromagnet having the superconductive coil according to the second to fourth embodiments. Alternatively, the charged particle beam therapy apparatus may include another superconductive electromagnet.

The magnet device 100 may be attached to an outer peripheral portion of the rotary gantry 23, for example, and may be used as a deflection electromagnet which is rotatable and movable together with the rotary gantry 23. Alternatively, the magnet device 100 may be used as a deflection electromagnet in the ESS 15 or the BTS 16.

In the above-described embodiments, a case has been described where the magnet device is used as the deflection electromagnet. However, without being limited to the case of being used as the deflection electromagnet, the magnet device according to certain embodiments of the present invention may be used for other purposes. The magnet device according to certain embodiments of the present invention may be a superconductive electromagnet used when accelerating a charged particle.

The winding density of the first coil portion may be greater than the winding density of the second coil portion, and the current value of the first coil portion may be greater than the current value of the second coil portion.

It should be understood that the invention is not limited to the above-described embodiment, but may be modified into various forms on the basis of the spirit of the invention. Additionally, the modifications are included in the scope of the invention.

What is claimed is:

1. A superconductive electromagnet device comprising:
a pair of superconductive coils that respectively have a first coil portion and a second coil portion which are arranged around a central axis;
a pair of iron cores that have a gap between the pair of superconductive coils in a direction of the central axis, and that form a pair of magnetic poles across the gap;
a first power source that supplies a current to the first coil portion which is arranged closer to the gap than the second coil portion; and
a second power source that supplies a current to the second coil portion.

2. A superconductive electromagnet device comprising:
a pair of superconductive coils that respectively have a first coil portion and a second coil portion which are arranged around a central axis; and
a pair of iron cores that have a gap between the pair of superconductive coils in a direction of the central axis, and that form a pair of magnetic poles across the gap,
wherein the first coil portion is arranged closer to the gap than the second coil portion, and
wherein winding density of the first coil portion is greater than winding density of the second coil portion.

3. A superconductive electromagnet device comprising:
a pair of superconductive coils that respectively have a first coil portion and a second coil portion which are arranged around a central axis; and
a pair of iron cores that have a gap between the pair of superconductive coils in a direction of the central axis, and that form a pair of magnetic poles across the gap,
wherein the first coil portion is arranged closer to the gap than the second coil portion, and
wherein current density of the first coil portion is greater than current density of the second coil portion.
